(19) United States
(12) Patent Application Publication
(10) Pub. No.: US 2026/0313526 A1
(43) Pub. Date: Oct. 8, 2026

(54) ESTABLISHING NETWORK SLICE CONNECTIONS IN HIGH-DEMAND GEOGRAPHICAL AREAS

(71) Applicant: T-Mobile USA, Inc., Bellevue, WA (US)

(72) Inventor: Jasinder Pal Singh, Olathe, KS (US)

(21) Appl. No.: 19/171,174

(22) Filed: Apr. 4, 2025

(51) Int. Cl. H04W 48/18; H04W 48/16; H04W 52/50; H04W 74/0833

(52) U.S. Cl. CPC H04W 48/18; H04W 48/16; H04W 52/50; H04W 74/0833

(57) ABSTRACT

A slice orchestrator establishes slice network connections in high-demand geographical regions by receiving a request from a user device to initiate an on-demand slice connection with a base station. The user device is located in a region serviced by a specific network slice connection associated with particular network slice selection assistance information (NSSAI) supported by an access and mobility management function (AMF). Multiple user devices in the region may be connected to this slice connection, and the request indicates the user device's status. The slice orchestrator determines if the number of connected devices exceeds a predefined threshold. If so, and the user device has the particular status, the network slice sub-management function (NSSMF) transmits a parameter set to the base station. This set includes the NSSAI and specifies a higher random access channel (RACH) power, enabling the base station to establish the on-demand network slice connection without interference.

### BACKGROUND

A network slice service is a virtualized network architecture that allows multiple isolated and independent end-to-end networks to be created on a shared physical infrastructure. Each network slice can be tailored to meet specific requirements, such as latency, bandwidth, and security, to enable customized services for different applications and user devices. This technology is fundamental in 5G networks, providing the flexibility to support diverse use cases, from enhanced mobile broadband to ultra-reliable low-latency communications and massive machine-type communications. By leveraging network slicing, service providers can efficiently allocate resources and optimize network performance to meet varying demands.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an example network slicing environment in a 5G network.

FIG. 4 is a block diagram that illustrates an environment for providing and managing network slice connections, in accordance with some embodiments.

FIG. 5 is a block diagram illustrating an environment for establishing slice network connections in high-demand geographical regions, in accordance with some embodiments.

FIG. 6 is a flowchart that illustrates a process for providing hybrid slice connections for devices in home internet, in accordance with some embodiments.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology is related to establishing on-demand network slice services for user devices located in high-demand geographical regions. An on-demand network slice service includes providing customers immediate access to a network slice connection upon a customer requesting it. An on-demand network slice service can be facilitated through a software application on a user device and be initiated by a user's request. In response to such a request, a network base station can establish such a slice connection for the user device. The process of establishing the network slice connection requires messaging between the network base station and the user device. However, in instances where the user device is located in a high-demand geographical region having a large number of users connected to a slice connection, the noise level of the communication channels becomes so high that the messages required for establishing the network slice connection can be interfered with. The high noise level in the high-demand geographical region can hinder the establishment of network slice connections, therefore reducing the customer's ability to connect to a slice connection upon a request. This can lead to the unreliable establishment of on-demand slice connections and reduction of customer experience.

An exemplary use case can be a mass event (e.g., a sports event, a concert, a public speech, or similar) where a large number of users are concentrated within a facility or a region (e.g., a stadium, a concert hall, a park, or a downtown region). A large number of users can be connected to an uplink slice (e.g., a link for transmitting from a user device to a base station) to, for example, transmit videos or make video calls. The uplink slice can thereby be in a high level of use, causing a high level of noise to the slice. When a user device within the region attempts to establish a slice connection to the same slice, the messaging from the user device to the base station to establish a slice connection can be interfered with by the noise, preventing the establishment of the connection. In some instances, such users may have specifically paid for the network slice connection and the failure to do so can cause a negative customer experience. In some instances, the user device can be associated with special applications related to public health or safety (e.g., associated with emergency vehicles, police, firemen, health care workers) or news broadcasting (e.g., by reporters or other broadcasters). In such instances, the failure to establish a network connection can cause a public safety or health risk or disturb the broadcasting of important information from the region.

The present technology provides for a method by a slice orchestrator ensuring that user devices having a special status are able to communicate messages to the base station to establish a slice network connection without interruptions due to noise. The special status can be associated with a payment or an application or device requesting a payment. For the special status user devices, the slice orchestrator can provide network slice selection assistance information (NSSAI) that identifies a higher than default random access channel (RACH) power. A RACH power refers to a transmission power used by a user device to transmit a request to a base station to access a network during the initial connection setup phase. High RACH power can be applied to ensure that the request is received clearly by the base station, even in challenging conditions such as high interference, thereby improving the chances of a successful and timely connection. A high RACH power can be defined in a parameter set provided by the slice orchestrator to the base station and further to the user devices that use the parameter set to configure messaging to establish the requested network slice.

In one example, a slice orchestrator for establishing slice network connections in high-demand geographical regions receives, from a user device, a request to initiate an on-demand slice connection with a base station. The user device can be located in a geographical region serviced with a particular network slice connection associated with a particular network slice selection assistance information (NSSAI) supported by an access and mobility management function (AMF) associated with the base station. Multiple user devices in the geographical region can be connected to the particular slice connection between the multiple user devices and the base station, and the request can indicate a particular status associated with the user device. The slice orchestrator can determine whether a number of the multiple user devices connected to the particular slice connection is above a predefined threshold number. Responsive to a determination that the number of the multiple user devices is above the predefined threshold number and that the user device is associated with the particular status, a network slice sub-management function (NSSMF) of the slice orchestrator can transmit to the base station a particular parameter set for establishing the on-demand network slice. The particular parameter set can include the particular NSSAI and defines a particular random access channel (RACH) power that is higher than a default RACH power used for establishing network slice connections. The higher RACH power can enable communication between the base station and the user device to establish the on-demand network slice connection without noise interference from the multiple user devices. By transmitting the particular parameter set, the slice orchestrator can cause the base station to establish the on-demand network slice connection between the base station and the user device using the higher RACH power.

In another example, a method can include receiving, by a slice orchestrator from a user device, a request to initiate an on-demand slice connection with a base station. The user device can be located in a geographical region serviced with a particular network slice connection associated with a particular network slice selection assistance information (NSSAI), where multiple user devices in the geographical region can be connected to the particular slice connection. The request can indicate a particular status associated with the user device. Responsive to a determination by the slice orchestrator that a number of the multiple user devices in the geographical region is above a predefined threshold number and that the user device is associated with the particular status, the method can include transmitting, to the base station by a network slice sub-management function (NSSMF) of the slice orchestrator, a particular parameter set for establishing the on-demand network slice. The particular parameter set can include the particular NSSAI and defines a particular random access channel (RACH) power that is higher than a default RACH power used for establishing network slice connections. By transmitting the particular parameter set, the slice orchestrator can cause the base station to establish the on-demand network slice connection between the base station and the user device using the higher RACH power.

In yet another example, a slice orchestrator receives from a user device a request to initiate an on-demand slice connection with a base station. The user device can be located in a geographical region serviced with a particular network slice connection associated with a particular network slice selection assistance information (NSSAI). Multiple user devices in the geographical region can be connected to the particular slice connection, and the request can indicate a particular status associated with the user device. Responsive to a determination that a number of the multiple user devices in the geographical region is above a predefined threshold number and that the user device is associated with the particular status, a network slice sub-management function (NSSMF) of the slice orchestrator can transmit to the base station a particular parameter set for establishing the on-demand network slice. The particular parameter set can include the particular NSSAI and define a particular random access channel (RACH) power that is higher than a default RACH power used for establishing network slice connections. By transmitting the particular parameter set, the slice orchestrator can cause the base station to establish the on-demand network slice connection between the base station and the user device using the higher RACH power.

### Wireless Communications System

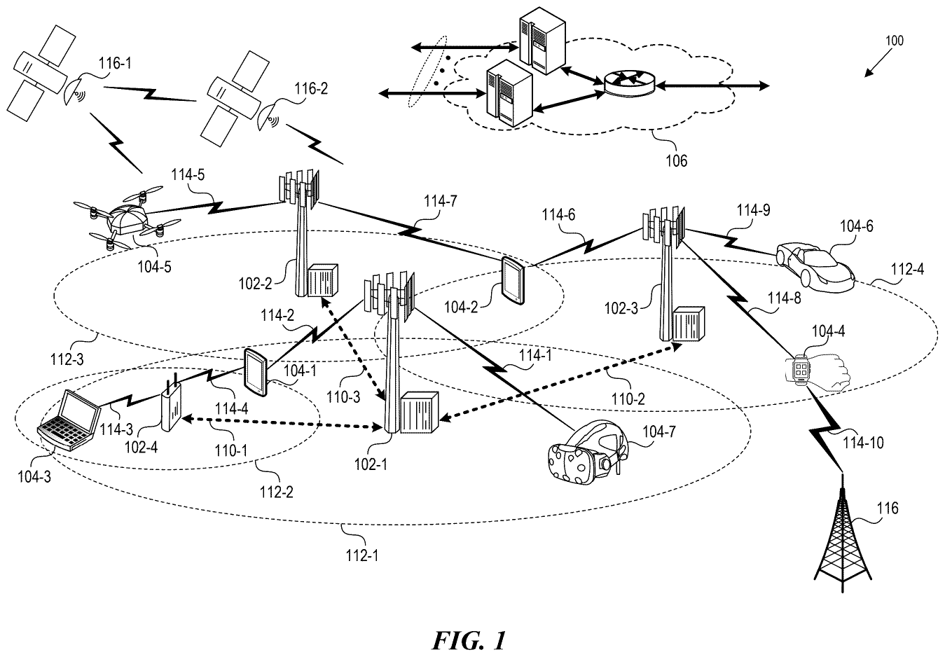

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a CPE, a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

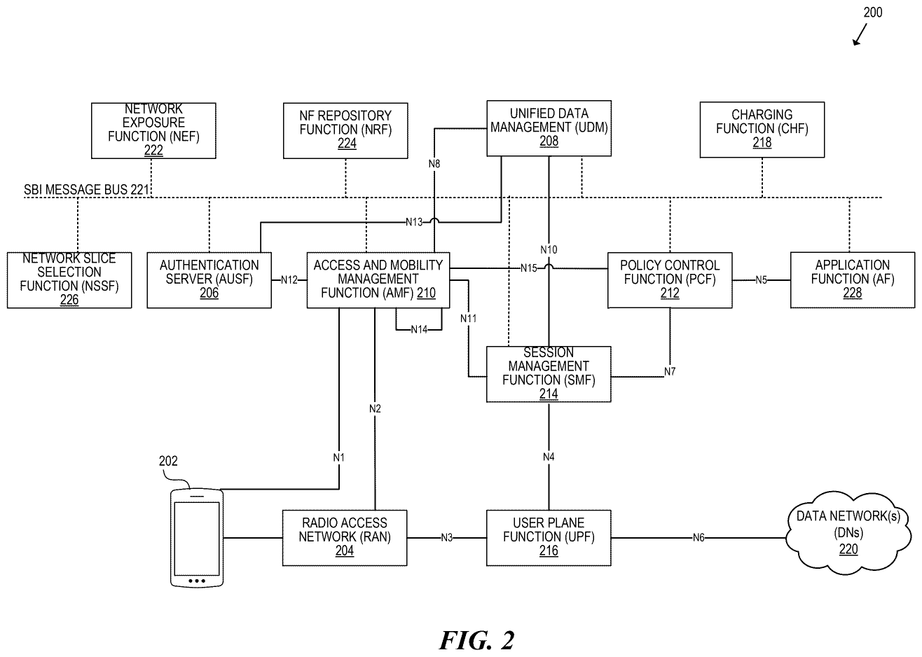

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Network Slice Connections in High-demand Geographical Regions

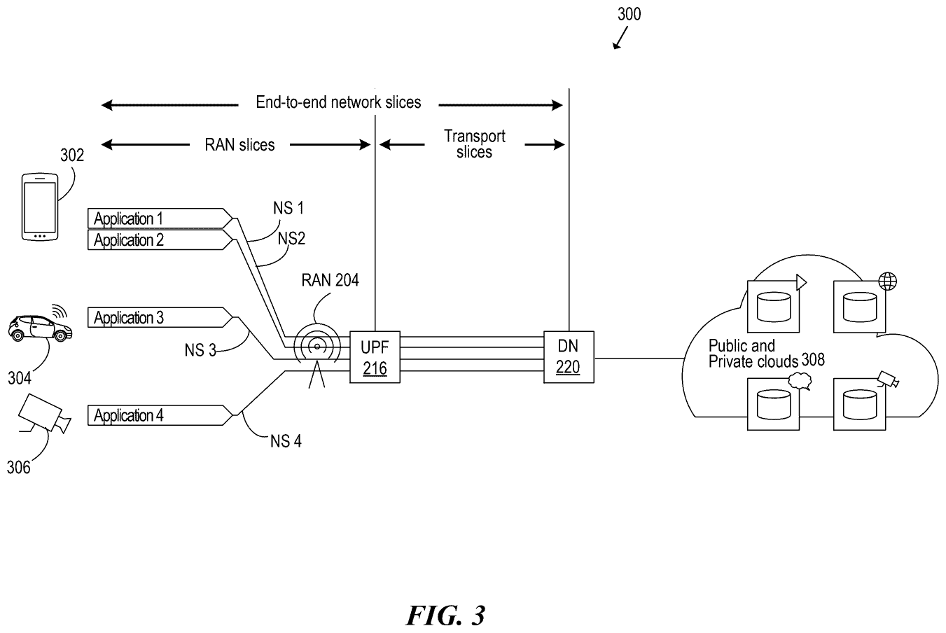

FIG. 3 is a block diagram that illustrates an example network slicing environment 300 in a 5G network. The network slicing environment 300 enables multiplexing of virtualized and independent logical networks (i.e., network slices NS1 through NS4) on the same physical network infrastructure. In 5G wireless networks, network slicing assumes a central role designed to efficiently embrace multiple services with very different service-level requirements (e.g., data transfer speed, reliability, bandwidth). The end-to-end network slices can be defined between wireless devices (e.g., wireless devices 302, 304, and 306) and DN 220. For example, each network slice is an isolated end-to-end network tailored to fulfill diverse requirements requested by a particular application (e.g., wireless applications 1 through 4 associated with the wireless devices 302, 304, and 306). The network slicing environment 300 can be in communication with public and private clouds 308. For example, the clouds 308 can include cloud servers associated with the different wireless applications 1 through 4. While FIG. 3 demonstrates a network slicing environment in a 5G network, one of skill in the art would understand that the features disclosed here would apply to other network topologies as well (e.g., 3G, 4G, 6G, and LTE).

An infrastructure associated with the network slicing system includes hardware and software resources, such as user equipment and/or compute-, storage-and networking-hardware equipment, as well as the services and software programs stored therein. The infrastructure can be used to implement physical network nodes and/or to define a distributed cloud environment, such as Physical Network Functions (PNFs) and/or the Network Functions Virtualization Infrastructure (NFVI). The infrastructure provides the support and management functionality that allows for the deployment and operation of individual network slices. The infrastructure can include a collection of PNFs. For example, it provides the user control and application plane functionality across the different network segments, including the RAN slices between wireless devices (e.g., wireless devices 302, 304, and 306) and the UPF 216 and transport slices between the UPF 216 and DN 220.

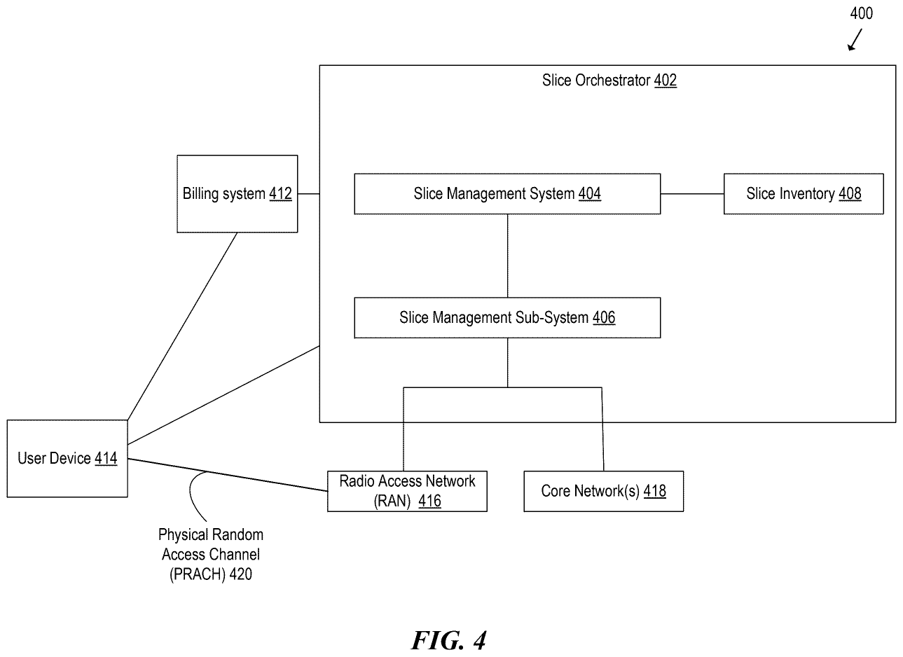

FIG. 4 is a block diagram that illustrates an environment 400 for providing and managing network slice connections in accordance with some embodiments. The environment 400 can include a slice orchestrator 402, a billing system 412, one or more radio access networks (e.g., the RAN 416), and core network functions 418 (e.g., corresponding to the core network functions 106 described with respect to FIG. 2). The environment 400 can be associated with the network 100 described with respect to FIG. 1. The environment 400 is in communication with multiple user devices (e.g., a user device 414) associated with a wireless network (e.g., the network 100 in FIG. 1). The RAN 416 and the core network functions 418 are associated with base stations (e.g., the base stations 102 in FIG. 1). The environment 400 is configured to provide network slice connections (e.g., the network slices NS1 through NS4 in FIG. 3) to the user devices and manage the slice connection operations, including establishing network slice connections between the user devices and the RAN 416.

The slice orchestrator 402 is configured to manage and allocate slice network resources dynamically to create multiple virtual networks on a shared physical infrastructure. For example, the slice orchestrator 402 facilitates the establishment of network slices such that each slice meets performance and service requirements. The slice orchestrator 402 can include a slice management system 404, a slice inventory 408, and a slice management sub-system 406. The slice management system 404 can include a communication service management function (CSMF) and a network slice management function (NSMF). The CSMF can be configured to act as an intermediary between a customer-facing service layer (e.g., the user device 414 and/or the billing system 412) and a network-facing management layer (e.g., the slice management sub-system 406). The NSMF can be configured to establish, monitor, and/or terminate network slice connections. For example, the NSMF can facilitate proper configuration of network slices and meeting requirements and service level agreements (SLAs) defined by the CSMF. The slice management system 404 can be in communication with the slice inventory 408. The slice inventory 408 can include a repository that facilitates tracking of the network slices, including their configurations, resources, and status, within a network slicing environment.

The slice management system 404 communicates with the slice-management sub-system 406. The slice-management sub-system 406 can include one or more network slice subnet management functions (NSSMFs). Each NSSMF can be associated with a particular network slice subnet (e.g., an R-NSSMF for the RAN 416 and a C-NSSMF for the core network functions 418). An NSSMF can manage resource allocation, slice configuration, and monitoring within its particular network slice subnet to ensure the proper functioning and performance of a network slice within the subnet.

The billing system 412 is in communication with the user devices, such as the user device 414. The billing system 412 can be configured to process payments, manage the usage data, calculate charges, and generate invoices for customers based on their service plans (subscriptions) and/or consumption. In some implementations, the communication is through a software application associated with the network 100 and operating on the user devices. For example, the software application is provided by a service provider associated with the network 100. A user can manage their network connections, including slice network connections, through the software application. A user can, for example, request an on-demand slice connection through the software application on their user device 414. In some implementations, the request can be associated with a payment. In such implementations, a user can make a payment (e.g., an online payment with a credit card) on their user device 414 (or on a different device). The payment can be received by the billing system 412, which then transmits an indication to the slice orchestrator 402 (e.g., the slice management system 404) that indicates that the user device 414 is requesting the on-demand network connection.

To establish an on-demand slice connection, the user device 414 can send a request (e.g., using the software application associated with the network 100) to initiate slice connection establishment to the RAN 416 via a PRACH 420. The request can include a PRACH preamble, which is a short, unique signal transmitted by the user device 414 to the RAN 416 to initiate the random-access procedure and establish initial communication. The PRACH preamble can include a preamble sequence that operates as an identifier for the attempt to initiate a slice connection and timing information (e.g., a timestamp). A PRACH preamble can be selected from a set of predefined PRACH preambles. For example, the set of PRACH preambles for the LTE and 5G NR networks includes 64 PRACH preambles. In some implementations, the communication between the user device 414 and the billing system, the slice orchestrator 402 and/or the base station for establishing on-demand slice connection can be facilitated by the software application on the user device 414.

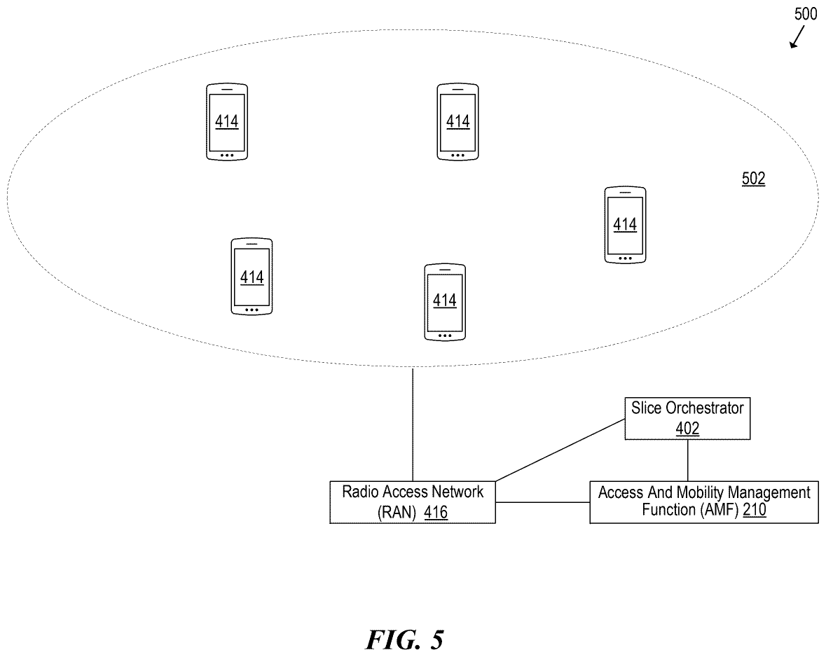

FIG. 5 is a block diagram illustrating an environment 500 for establishing slice network connections in high-demand geographical regions, in accordance with some embodiments. The environment 500 includes multiple user devices 414 located in a geographical region 502. The geographical region can correspond to a facility or area associated with mass events (e.g., a stadium, a concert hall, a park, or a downtown region). The user devices 414 can be connected to a network slice facilitated by a base station of the RAN 416. The base station is in communication with the slice orchestrator 402 described with respect to FIG. 4 and the AMF 210 of the architecture 200 described with respect to FIG. 2. The geographical region 502 can be considered a high-demand region for network connectivity in instances where a large number of user devices (e.g., a number of user devices above a threshold number of user devices) connects to a network slice concurrently. In a high-demand geographic region, establishing new network slice connections can be challenging because the noise caused by the existing connections can interfere with uplink messaging between a user device and the base station.

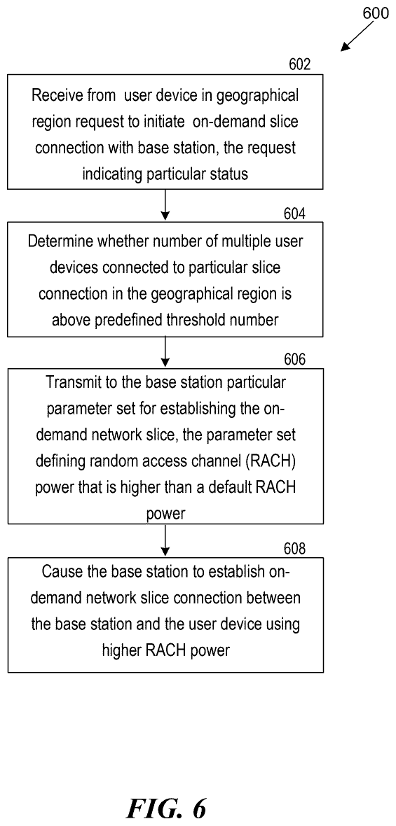

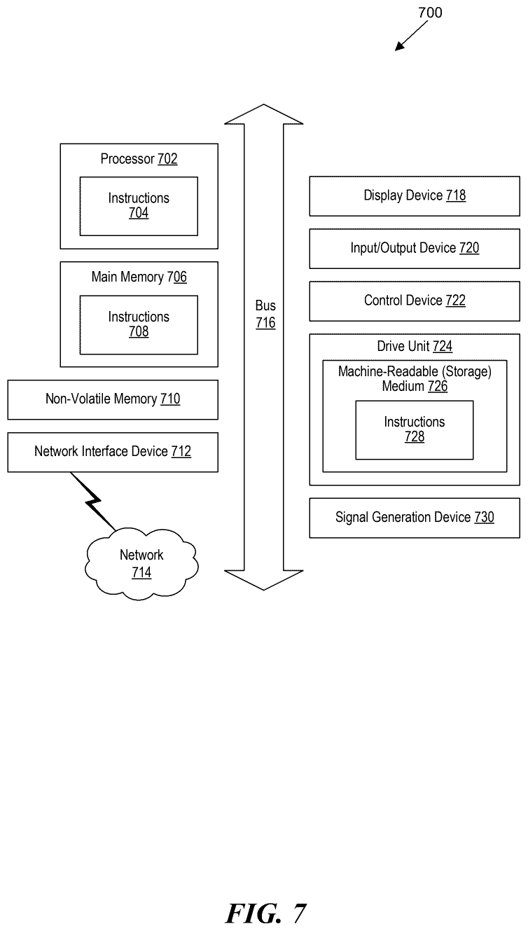

FIG. 6 is a flowchart that illustrates a process 600 for establishing slice network connections in high-demand geographical regions, in accordance with some embodiments. The process 600 can be performed by a slice orchestrator associated with a wireless network (e.g., the slice orchestrator 402 in FIG. 4 associated with the wireless network 100 in FIG. 1). The slice orchestrator can include at least one hardware processor and at least one non-transitory memory storing instructions (e.g., a computer system 700 described with respect to FIG. 7). When the instructions are executed by the at least one hardware processor, the device performs the process 700.

The process 600 is directed to establishing on-demand network slice services for user devices in high-demand areas. As explained above, in high-demand regions, the high noise level can interfere with the messaging required to establish these connections, leading to unreliable service and reduced customer experience. The process 600 provides that user devices with a special status can communicate messages to the base station without interruptions due to noise to facilitate the establishment of a slice network connection. This special status can be linked to a payment or an application/device requesting a payment. For these special status devices, the slice orchestrator provides network slice selection assistance information (NSSAI) that specifies a higher than default random access channel (RACH) power, ensuring clear transmission of requests to the base station even in high interference conditions and improving the chances of successful and timely connections.

At 602, the slice orchestrator receives from a user device (e.g., any of the user devices 414 in FIG. 5) a request to initiate an on-demand slice connection with a base station (e.g., a base station of the RAN 416 in FIG. 5). The base station can correspond to the base stations 102 of the network 100 described with respect to FIG. 1. The user device can be a wireless device, such as any of the wireless devices 104 described with respect to FIG. 1. The user device can be located in a geographical region (e.g., the geographical region 502 in FIG. 5) serviced with a particular network slice connection associated with a particular network slice selection assistance information (NSSAI). Multiple user devices in the geographical region can be connected to the particular slice connection between the multiple user devices and the base station.

The NSSAI includes a set of parameters associated with network slices. The parameters can include a slice/service type (ST) indicating a type of network slice (e.g., enhanced Mobile Broadband (eMBB), Ultra-Reliable Low-Latency Communications (URLLC), or massive Machine-Type Communications (mMTC)) and a slice differentiator (SD) providing differentiation within a same service type. In slice networking environments, NSSAI can enable identifying and selecting an appropriate network slice from a slice inventory (e.g., the slice inventory 408 in FIG. 4). The NSSAI parameters can allow the slice orchestrator to define and allocate slice network resources.

The particular NSSAI can be supported by an access and mobility management function (AMF) associated with the base station. An NSSAI supported by the AMF can include a set of parameters that the AMF (e.g., the AMF 210 in FIGS. 2 and 5) can recognize and manage and thereby use to enable the facilitation of an appropriate selection and allocation of network slices for connected devices. The NSSAI supported by the AMF is provided by the AMF to the base station during the configuration of packet data unit (PDU) sessions (e.g., a packet data transmission between a user device and a base station).

The request can indicate a particular status associated with the user device. In some implementations, the slice orchestrator can receive a request to initiate the on-demand slice connection that includes a payment by the user device, and the particular status can be defined based on the payment by the user device. In some implementations, the slice orchestrator can receive, from a billing system (e.g., the billing system 412 in FIG. 4), an indication that the user device has transmitted a payment for the on-demand slice network connection. The user device can be configured to generate the request to establish the on-demand network slice connection in response to receiving the payment from a user. The payment can be received via a software application on the user device. The payment can require an authorization from the user to, e.g., charge the user's account or a credit card. An indication that the payment has been made can be transmitted by the user device to a billing system and further to the slice orchestrator. In some implementations, no payment is required to generate the request. Instead, the user can provide an input via the software application on the user device to request for the on-demand network slice.

In some implementations, the particular status can be associated with a type of application (e.g., a software application operating on the user device) or a type of device that the on-demand slice connection is configured to be used for. The type can be associated, for example, with public health or safety (e.g., associated with emergency vehicles, police, firemen, health care workers) or news broadcasting (e.g., by reporters or other broadcasters).

At 604, the slice orchestrator can determine whether a number of the multiple user devices connected to the particular slice connection is above a predefined threshold number. The predefined threshold number of user devices can be determined by a base station's capacity. For example, the likelihood of having a noise interference level that can hinder the establishment of new network connections is above a certain likelihood when the number of user devices in the geographical area using the network slice is above the threshold. The slice orchestrator can determine how many user devices are concurrently using a network slice by, for example, collecting and analyzing real-time usage data from the AMF. Alternatively or additionally, instead of determining the number of user devices, the slice orchestrator can determine the number of active PDU sessions and whether the number of active PDU sessions is above a predefined threshold number of PDU sessions for the geographic area. The orchestrator can receive such information from a session management function (e.g., the SMF in FIG. 2), which can track and report the active PDU sessions and associated network slices for user devices.

Responsive to a determination that the number of the multiple user devices is above the predefined threshold number (or alternatively, the number of PDU sessions is above a predefined PDU session threshold number) and that the user device is associated with the particular status, at 606, a network slice sub-management function (NSSMF) (e.g., Slice Management Sub-System 406 in FIG. 4) of the slice orchestrator can transmit to the base station a particular parameter set for establishing the on-demand network slice. For example, the slice orchestrator defines the particular parameter set, which is then transmitted via the NSSMF to the base station. The particular parameter set can include the particular NSSAI (e.g., which is supported by the AMF) and defines a particular random access channel (RACH) power that is higher than a default RACH power used for establishing network slice connections. The particular parameter set can thereby define an NSSAI that is allowed to the user device having the particular status and that defines a higher RACH power. The higher RACH power can enable communication between the base station and the user device to establish the on-demand network slice connection without noise interference from the multiple user devices. As explained earlier, RACH power is the transmission power used by a user device to transmit a network access request to a base station during the initial connection setup. High RACH power, defined by parameters from the slice orchestrator, can ensure an appropriate reception of the request by the base station and thereby improve connection success in high noise conditions.

The particular parameter set can be generated and transmitted in response to the request from the user device. In an instance that the request is associated with a payment, the slice orchestrator can generate and transmit the particular parameter set responsive to receiving the indication that the user device has transmitted the payment (e.g., from the billing system 412).

At 608, by transmitting the particular parameter set, the slice orchestrator can cause the base station to establish the on-demand network slice connection between the base station and the user device using the higher RACH power. In particular, the base station can transmit the parameter set to the user device that can then use the parameter set to configure transmitting the request to the base station.

In some implementations, establishing the on-demand network slice connection between the base station and the user device can comprise broadcasting the particular parameter set by the base station to the user device as part of the system information block type 2 (SIB2) parameter set. The SIB2 can include essential radio resource configuration information, including parameters for random access, uplink power control, and common and shared channel configurations, which are required for the initial access by the user device. The SIB2 parameter set can be used by the user device to configure accessing the on-demand network slice connection. In some implementations, the higher RACH power can be used for messages from the user device to the base station to establish the on-demand network slice.

In some implementations, the AMF associated with the base station can support multiple network slice connections identified with different NSSAIs, and the slice orchestrator can be further caused to reduce RACH power for one or more of the multiple network slice connections identified with the different NSSAIs. Such one or more network slice connections can be identified by the slice orchestrators to be not in high demand (e.g., the number of user devices is below the threshold number of user devices in a geographic area). This can be performed to ensure that an overall RACH power supported by the base station remains constant to ensure stable and predictable communication service.

In some implementations, the slice orchestrator can receive, from an additional user device, an additional request to initiate an additional on-demand slice connection, where the request does not indicate the particular status. In such implementations, the slice orchestrator can transmit to the base station by NSSMF a default parameter set for establishing the additional on-demand slice connection. The default parameter set includes the particular NSSAI and defines the default RACH.

In some implementations, the slice orchestrator can, responsive to a determination that the number of the multiple user devices is below the predefined threshold number (e.g., there is no instance of high demand), transmit, to the base station by NSSMF, a default parameter set for establishing the on-demand slice connection. The default parameter set can include the particular NSSAI and define the default RACH.

In some implementations, the geographical region (e.g., the geographical region 502 in FIG. 5) can include a facility for mass events. The determination that the number of the multiple user devices is above the predefined threshold number can be performed during a particular mass event. The user device having the particular status can be associated with health or safety services or news broadcasting to ensure that services associated with health and safety or news broadcasting can operate without interruptions.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or include a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically include one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A slice orchestrator for establishing slice network connections in high-demand geographical regions, the slice orchestrator comprising:
at least one hardware processor; and
at least one non-transitory memory storing instructions, which, when executed by the at least one hardware processor, cause the slice orchestrator to:
receive, from a user device, a request to initiate an on-demand slice connection with a base station,
wherein the user device is located in a geographical region serviced with a particular network slice connection associated with a particular network slice selection assistance information (NSSAI) supported by an access and mobility management function (AMF) associated with the base station,
wherein multiple user devices in the geographical region are connected to the particular slice connection between the multiple user devices and the base station, and
wherein the request indicates a particular status associated with the user device,
determine, by the slice orchestrator, whether a number of the multiple user devices connected to the particular slice connection is above a predefined threshold number;
responsive to a determination that the number of the multiple user devices is above the predefined threshold number and that the user device is associated with the particular status,
transmit, to the base station by a network slice sub-management function (NSSMF) of the slice orchestrator, a particular parameter set for establishing the on-demand network slice,
wherein the particular parameter set includes the particular NSSAI and defines a particular random access channel (RACH) power that is higher than a default RACH power used for establishing network slice connections, and
wherein the higher RACH power enables communication between the base station and the user device to establish the on-demand network slice connection without noise interference from the multiple user devices;
by transmitting the particular parameter set, cause the base station to establish the on-demand network slice connection between the base station and the user device using the higher RACH power.

2. The slice orchestrator of claim 1,
wherein the request to initiate the on-demand slice connection includes a payment by the user device, and
wherein the particular status is defined based on the payment by the user device.

3. The slice orchestrator of claim 1, wherein the slice orchestrator is further caused to:
receive, from a billings system, an indication that the user device has transmitted a payment for the on-demand slice network connection,
wherein the particular parameter set is further transmitted responsive to receiving the indication that the user device has transmitted the payment.

4. The slice orchestrator of claim 1,
wherein the particular status is associated with a type of application or a type of device that the on-demand slice connection is configured to be used for.

5. The slice orchestrator of claim 1,
wherein the AMF associated with the base station supports multiple network slice connections identified with different NSSAIs, and
wherein the slice orchestrator is further caused to reduce RACH power for one or more of the multiple network slice connections identified with the different NSSAIs so that an overall RACH power supported by the base station remains constant.

6. The slice orchestrator of claim 1,
wherein establishing the on-demand network slice connection between the base station and the user device comprises broadcasting the particular parameter set by the base station to the user device as part of system information block type 2 (SIB2) parameter set, and
wherein the SIB2 parameter set is used by the user device to configure accessing the on-demand network slice connection.

7. The slice orchestrator of claim 1, wherein the slice orchestrator is further caused to:
receive, by the orchestrator from an additional user device, an additional request to initiate an additional on-demand slice connection, wherein the request does not indicate the particular status; and
transmit, to the base station by NSSMF, a default parameter set for establishing the additional on-demand slice connection,
wherein the default parameter set includes the particular NSSAI and defines the default RACH.

8. The slice orchestrator of claim 1, wherein the slice orchestrator is further caused to:
responsive to a determination that the number of the multiple user devices is below the predefined threshold number, transmit, to the base station by NSSMF, a default parameter set for establishing the on-demand slice connection,
wherein the default parameter set includes the particular NSSAI and defines the default RACH.

9. The slice orchestrator of claim 1,
wherein the geographical region includes a facility for mass events,
wherein the determination that the number of the multiple user devices is above the predefined threshold number is performed during a particular mass event, and
wherein the user device having the particular status is associated with health or safety services or news broadcasting.

10. The slice orchestrator of claim 1,
wherein the higher RACH power is used for messages from the user device to the base station to establish the on-demand network slice.

11. A method for establishing slice network connections in high-demand geographical regions, the method comprising:
receiving, by a slice orchestrator from a user device, a request to initiate an on-demand slice connection with a base station,
wherein the user device is located in a geographical region serviced with a particular network slice connection associated with a particular network slice selection assistance information (NSSAI),
wherein multiple user devices in the geographical region are connected to the particular slice connection, and
wherein the request indicates a particular status associated with the user device,
responsive to a determination, by the slice orchestrator, that a number of the multiple user devices in the geographical region is above a predefined threshold number and that the user device is associated with the particular status,
transmitting, to the base station by a network slice sub-management function (NSSMF) of the slice orchestrator, a particular parameter set for establishing the on-demand network slice,
wherein the particular parameter set includes the particular NSSAI and defines a particular random access channel (RACH) power that is higher than a default RACH power used for establishing network slice connections;
by transmitting the particular parameter set, causing the base station to establish the on-demand network slice connection between the base station and the user device using the higher RACH power.

12. The method of claim 11,
wherein the request to initiate the on-demand slice connection includes a payment by the user device, and
wherein the particular status is defined based on the payment by the user device.

13. The method of claim 11, further comprising:
receiving, from a billings system, an indication that the user device has transmitted a payment for the on-demand slice network connection,
wherein the particular parameter set is further transmitted responsive to receiving the indication that the user device has transmitted the payment.

14. The method of claim 11,
wherein the particular status is associated with a type of application or a type of device that the on-demand slice connection is configured to be used for.

15. The method of claim 11,
wherein an access and mobility management function (AMF) associated with the base station supports multiple network slice connections identified with different NSSAIs, and
wherein the slice orchestrator is further caused to reduce RACH power for one or more of the multiple network slice connections identified with the different NSSAIs so that an overall RACH power supported by the base station remains constant.

16. A non-transitory, computer-readable storage medium comprising instructions for managing healthcare sessions recorded thereon, wherein the instructions, when executed by at least one data processor of a slice orchestrator associated with a telecommunications network, cause the slice orchestrator to:
receive, from a user device, a request to initiate an on-demand slice connection with a base station,
wherein the user device is located in a geographical region serviced with a particular network slice connection associated with a particular network slice selection assistance information (NSSAI),
wherein multiple user devices in the geographical region are connected to the particular slice connection, and
wherein the request indicates a particular status associated with the user device,
responsive to a determination that a number of the multiple user devices in the geographical region is above a predefined threshold number and that the user device is associated with the particular status, transmit, to the base station by a network slice sub-management function (NSSMF) of the slice orchestrator, a particular parameter set for establishing the on-demand network slice,
wherein the particular parameter set includes the particular NSSAI and defines a particular random access channel (RACH) power that is higher than a default RACH power used for establishing network slice connections;
by transmitting the particular parameter set, cause the base station to establish the on-demand network slice connection between the base station and the user device using the higher RACH power.

17. The non-transitory, computer-readable storage medium of claim 16,
wherein the request to initiate the on-demand slice connection includes a payment by the user device, and
wherein the particular status is defined based on the payment by the user device.

18. The non-transitory, computer-readable storage medium of claim 16, further comprising:
receiving, from a billings system, an indication that the user device has transmitted a payment for the on-demand slice network connection,
wherein the particular parameter set is further transmitted responsive to receiving the indication that the user device has transmitted the payment.

19. The non-transitory, computer-readable storage medium of claim 16,
wherein the particular status is associated with a type of application or a type of device that the on-demand slice connection is configured to be used for.

20. The non-transitory, computer-readable storage medium of claim 16,
wherein an access and mobility management function (AMF) associated with the base station supports multiple network slice connections identified with different NSSAIs, and
wherein the slice orchestrator is further caused to reduce RACH power for one or more of the multiple network slice connections identified with the different NSSAIs so that an overall RACH power supported by the base station remains constant.
